(19) United States
(12) Patent Application Publication
(10) Pub. No.: US 2014/0219685 A1
(43) Pub. Date: Aug. 7, 2014

(54) Image Application Unit for Use with Liquid Toner and Digital Printing Unit Comprising Same

(71) Applicant: Xeikon IP BV, Eede (NL)

(72) Inventors: Lode Erik Dries Deprez, Wachtebeke (BE); Jurgen Norbert Bart Devlieghere, Borgerhout (BE)

(73) Assignee: Xeikon IP BV, Eede (NL)

(21) Appl. No.: 14/167,299

(22) Filed: Jan. 29, 2014

(30) Foreign Application Priority Data
Feb. 7, 2013 (EP) 13 154 319.1

(51) Int. Cl. G03G 15/10

(52) U.S. Cl. CPC G03G 15/101
USPC 399/237

(57) ABSTRACT

Disclosed is an image application unit for use with liquid toner, suitable for transferring an image to a drum rotating around a vertical axis or a printing substrate guided by such a drum. The image application unit includes: a liquid toner dosing assembly; an imaging member sustaining a pattern of electric charge forming a latent image on its surface, and arranged to transfer it after development to said drum or said substrate; and a development member arranged to receive liquid toner from the dosing assembly, and to develop the latent image by transferring a portion of the liquid toner onto the imaging member in accordance with the pattern. The liquid toner dosing assembly is adapted for vertical use and the development member and the imaging member are configured for rotation around vertical axes.

### CROSS-REFERENCE TO RELATED APPLICATIONS

This application claims priority to European Patent Application No. 13 154 319.1 filed Feb. 7, 2013, the disclosure of which is hereby incorporated by reference in its entirety.

### BACKGROUND OF THE INVENTION

1. Field of the Invention

The present invention pertains to the field of digital printing apparatus, in particular systems using liquid toner.

2. Description of Related Art

Digital printing apparatus using liquid toner are known from US patent application publication no. 2009/0052948. In the known systems, the various members involved in the printing process are made to rotate around a horizontal axis. In particular, the printing substrate—typically an elongate sheet of paper deployed from a roll—is guided along a drum that rotates around a horizontal axis. Hereinafter, a printing substrate will be said to be horizontally oriented when the transverse direction of the substrate is parallel to the horizontal plane.

It is known that the existing liquid toner based systems can be used for color printing, by providing several printing stages that operate with toner having different colors. Printing systems with four colors are common, as it is well understood that a wide range of colors can be obtained by appropriately combining cyan, magenta, yellow, and black.

It is a disadvantage of the known systems that the various color stations have to be arranged around the drum that guides the printing substrate at different angles to the horizontal plane, such that the individual stations need to be designed with their position in the system in mind. It is a further disadvantage that the total number of color stations that can be positioned around a single drum is limited by the space available in the relatively small areas in which the stations have a suitable angle relative to the main drum.

Another problem of existing systems that don't use a central drum but rather print successively on the substrate is that it is very difficult to obtain good registration (spatial alignment) of the respective stations, which is crucial to obtain high-quality color prints.

It is therefore an object of embodiments of the present invention to overcome some or all of the above mentioned problems.

### SUMMARY OF THE INVENTION

According to an aspect of the present invention, there is provided an image application unit for use with liquid toner, the image application unit being suitable for transferring an image to a drum rotating around a substantially vertical axis or a printing substrate guided by such a drum, the image application unit comprising: a liquid toner dosing assembly; an imaging member adapted to sustain a pattern of electric charge forming a latent image on its surface, and arranged to transfer the latent image after development to the drum or the printing substrate; and a development member arranged to receive a quantity of liquid toner from the liquid toner dosing assembly, and to develop the latent image by transferring a portion of the quantity of liquid toner onto the imaging member in accordance with the pattern; wherein the liquid toner dosing assembly is adapted for substantially vertical use; wherein the development member is configured for rotation around a first substantially vertical axis; and wherein the imaging member is configured for rotation around a second substantially vertical axis.

Throughout the application, the terms “substantially horizontal” and “substantially vertical” are used to designate orientations that are actually horizontal or vertical, respectively, or that lie within a small margin—e.g. less than 15°, preferably less than 5°, and more preferably less than 1°—of a horizontal or vertical orientation, respectively. For optimal operation of the apparatus described herein, it is generally preferred to arrange all “substantially vertical” elements truly vertically, or at least as close to the actual vertical as practically possible.

The term “image application unit” is used herein to designate a single-color digital printing station. The present invention is based inter alia on the insight of the inventors that by changing the orientation of the image application unit from horizontal (i.e., all revolving elements rotate around a substantially horizontal axis) to vertical (i.e., all revolving elements rotate around a substantially vertical axis), the unit can be used to print on a substrate that is guided by a drum that is also rotating around a substantially vertical axis. With respect to such a drum, all angular positions at the periphery of the drum are equivalent, allowing not only for the use of multiple identical units, but also allowing for an increase in the total number of units arranged around the drum.

It should be noted that the change in orientation is counter-intuitive, in the sense that gravity acts along the length direction of the various rotating members of the drum, which could affect the uniformity of the layers of liquid toner present at the surface of the various revolving members. The inventors have found, surprisingly, that a sufficiently thin layer of toner will not be disturbed by gravity, because the effects of adhesion and surface tension outweigh the effects of gravity.

Where it is stated that the unit according to the present invention is suitable for printing on a printing substrate guided by a drum rotating around a vertical axis, it is not limited to such use. Generally, a benefit of the invention lies in the possibility of printing on a vertically oriented printing substrate, or a substrate being conveyed in a substantially horizontal direction. Such a vertically oriented substrate may in fact be guided by a drum, a roll, a (metal) plate, a belt, or any other suitable means as is readily known to a person skilled in the art.

In an embodiment, the image application unit according to the present invention further comprises an intermediate member, operatively arranged between the imaging member and the printing substrate, the intermediate member being configured for rotation around a third substantially vertical axis.

In a particular embodiment, the intermediate member has a surface which is more elastic than a surface of the imaging member.

It is an advantage of this embodiment that the better printing results may be obtained with coarse substrates, thanks to the compressibility of the surface of the intermediate member. Preferably, the elasticity is obtained by providing the intermediate member with a surface made of an elastomer.

In an embodiment of the image application unit according to the present invention, the liquid toner dosing assembly comprises: an elongate reservoir having a first end and a second end, which, in use, constitute the bottom and the top of the reservoir, respectively; a liquid toner inlet orifice provided at the first end; a liquid toner outlet orifice provided at the second end; a dosing slit; and a toner supply member for supplying liquid toner to the development member, the toner supply member being arranged parallel to the dosing slit so as to cover the dosing slit without sealing it.

The expressions “at the first end” and “at the second end” are understood to mean that the orifice is either provided in the respective end wall (bottom or top) of the reservoir, or in another wall of the reservoir in proximity of the respective end.

By arranging the toner supply member in such a way as to cover the dosing slit, no liquid toner will flow from the slit, even in vertical position, unless the toner supply member is activated (in rotation). The skilled person will appreciate that the spatial relationship between the slit and the toner supply member is not such as to completely seal the slit—in which case the toner supply member would not be able to supply any toner—but merely to close it to such an extent that a thin layer adhering to the surface of the toner supply member is capable of exiting from the reservoir as the relevant part of the surface moves from the inside of the reservoir to the outside.

It is noted that liquid toner with a high enough solid content concentration has a non-newtonian behavior. Under low shear rates (e.g. when standing still or almost still), the viscosity dramatically increases, and further hinders movement of the toner, increasing the effect. The result is that concentrated liquid toner solidifies and is no longer liquid. This effect is called “caking”. It is a further advantage of the present embodiment that fresh liquid toner can continuously be supplied by a liquid toner supply system (e.g. comprising a pump and a further reservoir with fresh liquid toner) from the bottom of the reservoir, while the necessary quantity is dispensed through the dosing slit and the excess is evacuated from the top of the reservoir. Thus, the liquid toner in the reservoir remains in motion, avoiding or reducing the risk of solidification or “caking” inside the reservoir. To further reduce the risk of having “dead zones” in the reservoir where the liquid toner would stand still, it is further possible to use multiple liquid toner inlet orifices (for example two or four) and/or multiple liquid toner outlet orifices (for example two or four).

In a particular embodiment, the liquid toner dosing assembly further comprises means to prevent leakage of liquid toner from the reservoir through the dosing slit.

In cases where more clearance is desired between the slit and the toner supply member, it is advantageous to provide additional means, optionally cooperating with the toner supply member, to prevent leakage of toner from the reservoir. Such means may include blades or seals, made for example of an elastomeric material.

According to an aspect of the present invention, there is provided a digital printing apparatus comprising: a main drum, adapted to guide a printing substrate, the main drum having a rotation axis which, in use, is arranged substantially vertically; and a plurality of image application units as described above, arranged around the main drum to transfer respective images to the printing substrate.

According to an aspect of the present invention, there is provided a digital printing apparatus comprising: a main drum having a rotation axis which, in use, is arranged substantially vertically; a plurality of image application units as described above, arranged around the main drum to transfer respective images to said drum; and transfer means to transfer the respective images from the. main drum to the printing substrate.

In a specific embodiment, the transfer means comprises a transfuse carrier and a heater, the transfuse carrier being arranged to contact the main drum in a first zone and to contact the printing substrate in a second zone; and the heater is arranged to at least partly heat the transfuse carrier downstream of the first zone and upstream of the second zone.

In a more specific embodiment, the transfer means further comprises a cooler, arranged to at least partly cool the transfuse carrier downstream of the second zone and upstream of the first zone.

The advantages described above with respect to the individual image application units, apply to the same extent to the digital printing apparatus according to the invention

It is a further advantage of the invention that the movement of the members of the image application units can easily be synchronized with the movement of the main drum, thus avoiding the introduction of undesirable shear forces into the printing substrate.

In an embodiment, the digital printing apparatus according to the present invention further comprises a first substrate turning device arranged to turn a printing substrate fed into the apparatus from a substantially horizontal orientation to a substantially vertical orientation.

In an embodiment, the digital printing apparatus according to the present invention further comprises a second substrate turning device arranged to turn a printing substrate ejected from the apparatus from a substantially vertical orientation to a substantially horizontal orientation.

These embodiments are particularly advantageous in conditions where the printing substrate must undergo additional processing before or after the printing step. Existing machines are often designed to deal with horizontally oriented feeds of paper only (i.e., where the transverse direction of the paper strip is substantially parallel to the horizontal plane), while the image application units according to the invention operate on substantially vertically oriented feeds.

In an embodiment of the digital printing apparatus according to the present invention, the number of image application units is at least four.

In a particular embodiment, respective ones of the liquid toner dosing assemblies comprise liquid toner colored cyan, magenta, yellow, and black.

These embodiments meet the most common color printing needs.

In a particular embodiment, the number of image application units is at least five.

It is an advantage of this embodiment that the printing apparatus can be made to print colors outside the color gamut covered by cyan, magenta, and yellow, including for example additional base colors to span a more extensive color gamut, customer specific colors (such as colors appearing in a logo or trademark), white (in particular for printing white portions on non-white substrates), and “clear” (e.g., varnishes as used on labels and packaging materials). Several such additional toner colors or types can be used in embodiments with six, seven, or eight image application units.

In an embodiment of the digital printing apparatus according to the present invention, the image application units are of substantially identical construction.

This embodiment greatly facilitates the construction of the printing apparatus.

According to an aspect of the present invention, there is provided a use of a digital printing apparatus as described above for printing on a printing substrate guided by a drum rotating around a substantially vertical axis.

According to an aspect of the present invention, there is provided a liquid toner dosing assembly for use in the image application unit as described above, the liquid toner dosing assembly comprising: an elongate reservoir having a first end and a second end, which, in use, constitute the bottom and the top of the reservoir, respectively; a liquid toner inlet orifice provided at the first end; a liquid toner outlet orifice provided at the second end; a dosing slit; and a toner supply member for supplying liquid toner to the development member, the toner supply member being arranged parallel to the dosing slit so as to cover the dosing slit without sealing it.

In an embodiment, the liquid toner dosing assembly according to the present invention further comprises means to prevent leakage of liquid toner from the reservoir through the dosing slit.

In an embodiment, the liquid toner dosing assembly according to the present invention further comprises a drainage orifice at said first end.

It is an advantage of this embodiment that the reservoir can easily be emptied when not in use, to avoid caking of liquid toner inside the reservoir, without having to uncouple the tubes that may be coupled to the liquid toner inlet orifice.

### BRIEF DESCRIPTION OF THE DRAWINGS

These and other aspects and advantages of the present invention will now be described in more detail with reference to the accompanying drawings, in which:

FIG. 1 provides a front and top view (not to scale) of a liquid toner dosing assembly according to an embodiment of the present invention;

FIG. 2 provides a front and top view (not to scale) of an image application unit according to an embodiment of the present invention;

FIG. 3 provides a top view (not to scale) of a digital printing apparatus according to an embodiment of the present invention; and

FIG. 4 provides a top view (not to scale) of a digital printing apparatus according to another embodiment of the present invention.

### DESCRIPTION OF THE INVENTION

Throughout the application, the various stages of the printing system have been described as “members”. In specific cases, these members have been described and/or illustrated as rollers. The skilled person will appreciate that the same principles may be applied with suitably designed belts.

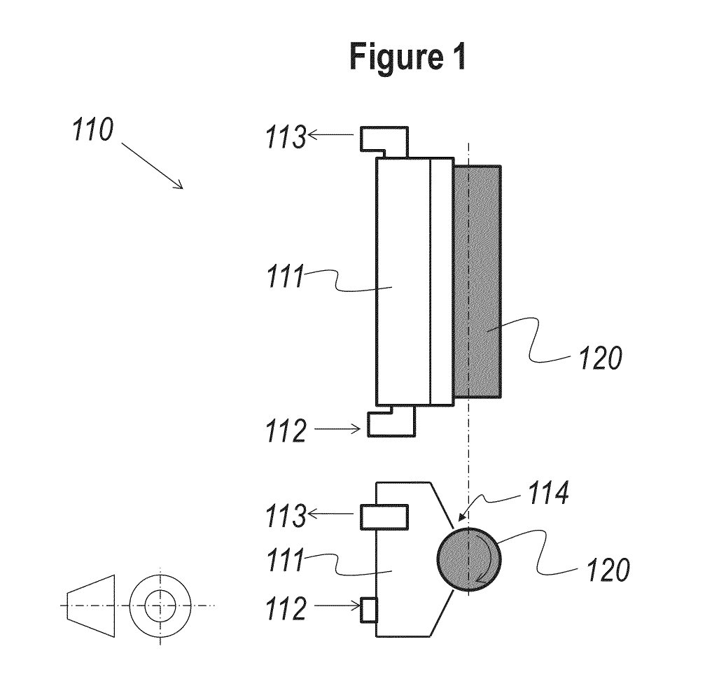

FIG. 1 illustrates an exemplary liquid toner dosing assembly 110 for use in the image application unit 100 according to the present invention. The liquid toner dosing assembly 110 comprises an elongate reservoir 111 with a liquid toner inlet orifice 112 provided at the bottom end and a liquid toner outlet orifice 113 provided at the top end, a dosing slit 114, and a toner supply member 120 for supplying liquid toner to a development member 130. The toner supply member 120 is arranged parallel to the dosing slit 114 so as to cover it without sealing it.

The terms “bottom end” and “top end” refer to the transverse walls of the reservoir which are at the bottom and the top side, respectively, when the assembly is installed for use.

With reference to this orientation of the assembly, the toner supply member 120 and the dosing slit 114 are substantially vertically oriented. A flexible flap, seal, or other suitable means (not illustrated) may be provided to prevent leakage of liquid toner from the assembly via the dosing slit.

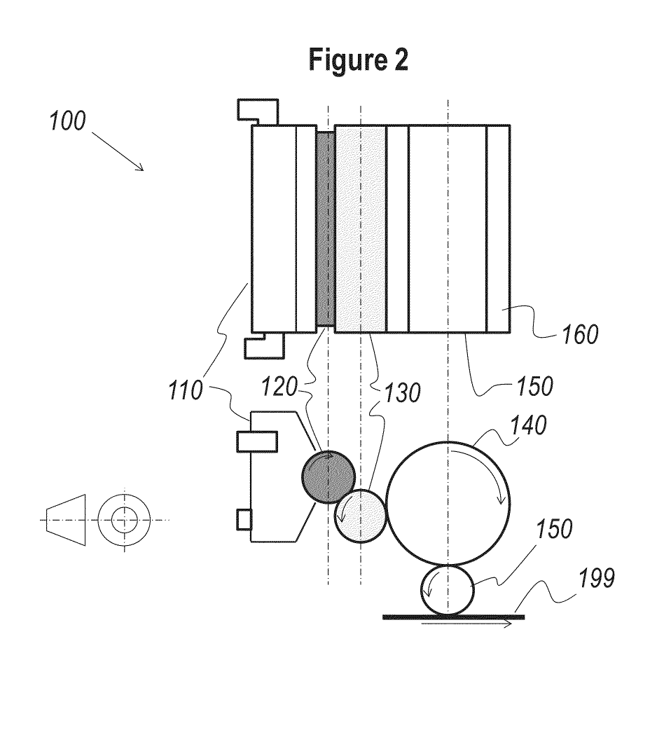

FIG. 2 illustrates an exemplary image application unit 100 for use with liquid toner, according to an embodiment of the present invention. The image application unit 100 is suitable for transferring an image to a drum 160 rotating around a vertical axis or a printing substrate 199 guided by such a drum 160.

The image application unit 100 comprises a liquid toner dosing assembly 110 which is adapted for substantially vertical use. Preferably, a liquid toner dosing assembly 110 as described in connection with FIG. 1 is used.

The image application unit 100 further comprises a development member 130 arranged to receive a quantity of liquid toner 100 from said liquid toner dosing assembly 110, in particular from the latter's toner supply member 120.

Next, the image application unit 100 comprises an imaging member 140 adapted to sustain a pattern of electric charge forming a latent image on its surface (typically, a photoconductive roll, which is charged and then selectively uncharged by selective exposure to light). This latent image is developed to an actual toner image by contact with the development member 130, at which point a portion of the quantity of liquid toner present on the development member 130 is transferred onto the imaging member 140 in accordance with the charge pattern.

The imaging member 140 is configured for rotation around a second substantially vertical axis and arranged to transfer the latent image after development to the drum 160, to the printing substrate 199, or to an intermediate member 150 arranged between the imaging member 140 and the printing substrate 199, all of which also have a substantially vertical operational orientation.

If an intermediate member 150 is provided, it preferably has a surface which is more elastic than a surface of said imaging member 140.

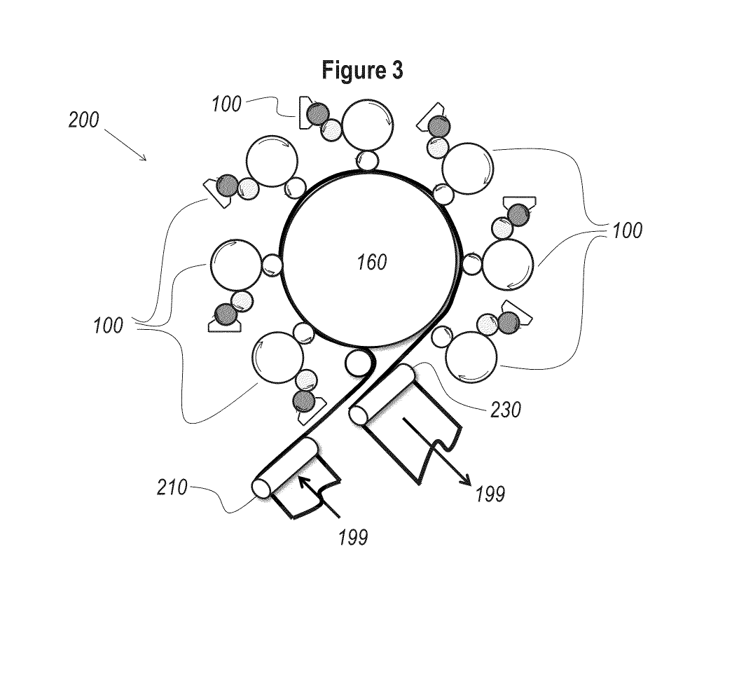

FIGS. 3 illustrates a first exemplary printing apparatus 200 according to an embodiment of the present invention.

This variant 200 includes a main drum 160 adapted to guide a printing substrate 199. The main drum 160 having a rotation axis which, in use, is arranged substantially vertically. This variant 200 further comprises a plurality of image application units 100, preferably such as the one described in connection with FIG. 2, arranged around the main drum 160 to transfer respective images to the printing substrate 199, optionally via an intermediate member 150.

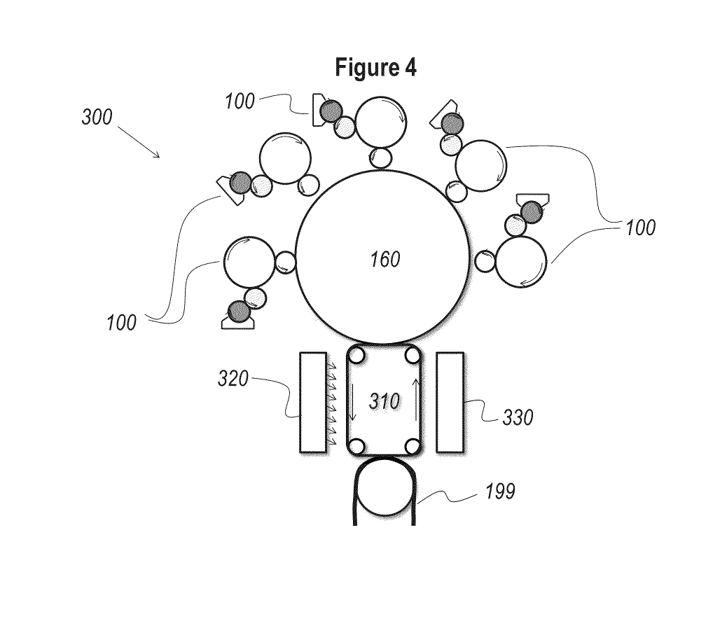

FIG. 4 illustrates a second exemplary printing apparatus 300 according to an embodiment of the present invention. This variant also includes a main drum 160 having a rotation axis which, in use, is arranged substantially vertically.

This variant 200 further also comprises a plurality of image application units 100, preferably such as the one described in connection with FIG. 2, arranged around the main drum 160 to transfer respective images to the main drum 160, optionally via an intermediate member 150. Accordingly, the different color patterns making up the final image are first combined on the main drum 160, and not on the substrate 199 as in the previous variant. This variant therefore further comprises transfer means to transfer the respective images from the main drum 160 to the printing substrate 199.

The transfer means may comprise a transfuse carrier 310, a heater 320, and optionally a cooler 330. Without limitation, the transfuse carrier 320 may be a roll (drum) or a belt. The transfuse carrier 310 is arranged to contact the main drum 160 in a first zone and to contact the printing substrate 199 in a second zone. The heater 320 and the cooler 330 are preferably arranged alongside the transfuse carrier 320, on opposite sides, between the first zone and the second zone. In particular, the heater heats the carrier when it carries the image, so as to cause the volatile portion of the liquid toner to evaporate; for this purpose, the heater 320 is arranged to at least partly heat the transfuse carrier 310 downstream of the first zone and upstream of said second zone. The cooler. cools the carrier after it has contacted the printing substrate 199 and transferred the image to the latter, i.e. when it returns to the main drum 160; for this purpose, the cooler 330 is arranged to at least partly cool the transfuse carrier 310 downstream of the second zone and upstream of the first zone.

It is an advantage of the second variant that the image is at least partially fused prior to being transferred to the final printing substrate 199, such that the need to heat the printing substrate 199, which may be damaging to certain types of substrates 199, is reduced or eliminated.

A number of preferences and options will now be described, which apply to printing apparatus according to the present invention regardless of the specific variant.

The digital printing apparatus 200/300 according to the present invention may comprise a substrate turning device 210 (not shown in FIG. 4) to turn a printing substrate 199 fed into the apparatus 200/300 from a substantially horizontal orientation to a substantially vertical orientation and/or a substrate turning device 230 (not shown in FIG. 4) arranged to turn a printing substrate 199 ejected from the apparatus 200/300 from a substantially vertical orientation to a substantially horizontal orientation.

Preferably, the number of image application units 100 in digital printing apparatus 200/300 is at least four. These units 100 preferably the respective liquid toner dosing assemblies 110 comprise liquid toner colored cyan, magenta, yellow, and black.

Further colors or special coatings may be used in the printing process if the digital printing apparatus 200/300 has at least five image application units 100. Specially preferred embodiments have six, seven, or eight image application units 100.

Preferably, the respective image application units 100 are of substantially identical construction.

One or more of the revolving members of the image application unit may be provided with a mechanical toner removal device, optionally aided by electrophoretic loosening as described in co-pending European patent application no. 12 175 762.9 in the name of the present Applicant, filed on 10 Jul. 2012, the content of which is specifically incorporated by reference for this purpose. Such a device, which may include a scraper, comb, or blade, is particularly effective in the context of the image application unit according to the present invention, because the substantially vertical orientation of the members allow for gravity-aided removal of the excess toner. Thus, the mechanical device will experience a relatively high flow of liquid toner, which reduces the degree of condensing or “caking” that typically occurs when liquid toner is left stagnant for a certain period of time.

A more complete description of the electrostatographic printing process may be found in the aforementioned European patent application no. 12 175 762.9.

While the invention has been described hereinabove with reference to specific embodiments, this is done to illustrate and not to limit the invention. The skilled person will appreciate that other ways of implementing the inventive concept described herein are within the scope of the invention, as defined by the accompanying claims.

1-19. (canceled)

20. An image application unit for use with liquid toner, said image application unit being suitable for transferring an image to a drum rotating around a substantially vertical axis or a printing substrate guided by such a drum, said image application unit comprising:
a liquid toner dosing assembly;
an imaging member adapted to sustain a pattern of electric charge forming a latent image on its surface, and arranged to transfer said latent image after development to said drum or said printing substrate; and
a development member arranged to receive a quantity of liquid toner from said liquid toner dosing assembly, and to develop said latent image by transferring a portion of said quantity of liquid toner onto said imaging member in accordance with said pattern;
wherein said liquid toner dosing assembly is adapted for substantially vertical use;
wherein said development member is configured for rotation around a first substantially vertical axis; and
wherein said imaging member is configured for rotation around a second substantially vertical axis.

21. The image application unit of claim 20, further comprising an intermediate member, operatively arranged between said imaging member and said printing substrate, said intermediate member being configured for rotation around a third substantially vertical axis.

22. The image application unit of claim 21, wherein said intermediate member has a surface which is more elastic than a surface of said imaging member.

23. The image application unit of claim 20, wherein said liquid toner dosing assembly comprises:
an elongate reservoir having a first end and a second end, which, in use, constitute the bottom and the top of said reservoir, respectively;
a liquid toner inlet orifice provided at said first end;
a liquid toner outlet orifice provided at said second end;
a dosing slit; and
a toner supply member for supplying liquid toner to said development member, said toner supply member being arranged parallel to said dosing slit so as to cover said dosing slit without sealing it.

24. The image application unit of claim 23, wherein said liquid toner dosing assembly further comprises means to prevent leakage of liquid toner from said reservoir through said dosing slit.

25. The image application unit of claim 23, wherein said liquid toner dosing assembly further comprises a liquid toner supply system to continuously supply liquid toner through the liquid toner inlet orifice and to remove excess liquid toner from the liquid toner outlet orifice.

26. A digital printing apparatus comprising:
a main drum, adapted to guide a printing substrate, said main drum having a rotation axis which, in use, is arranged substantially vertically; and
a plurality of image application units, arranged around said main drum to transfer respective images to said printing substrate;
wherein an image application unit of said plurality of image application units comprises:
a development member arranged to receive a quantity of liquid toner from said liquid toner dosing assembly, and to develop said latent image; wherein said development member is configured for rotation around a first substantially vertical axis;
a liquid toner dosing assembly comprising:
an elongate reservoir having a first end and a second end, which, in use, constitute the bottom and the top of said reservoir, respectively;
a liquid toner inlet orifice provided at said first end;
a liquid toner outlet orifice provided at said second end;
a dosing slit; and
a toner supply member for supplying liquid toner to said development member, said toner supply member being arranged parallel to said dosing slit so as to cover said dosing slit without sealing it.

27. The digital printing apparatus of claim 26, wherein said liquid toner dosing assembly further comprises a liquid toner supply system to continuously supply liquid toner through the liquid toner inlet orifice and to remove excess liquid toner from the liquid toner outlet orifice.

28. A digital printing apparatus comprising:
a main drum having a rotation axis which, in use, is arranged substantially vertically;
a plurality of image application units arranged around said main drum to transfer respective images to said main drum; and
transfer means to transfer said respective images from said main drum to said printing substrate;
wherein an image application unit of said plurality of image application units comprises:
a development member arranged to receive a quantity of liquid toner from said liquid toner dosing assembly, and to develop said latent image; wherein said development member is configured for rotation around a first substantially vertical axis;
a liquid toner dosing assembly comprising:
an elongate reservoir having a first end and a second end, which, in use, constitute the bottom and the top of said reservoir, respectively;
a liquid toner inlet orifice provided at said first end;
a liquid toner outlet orifice provided at said second end;
a dosing slit; and
a toner supply member for supplying liquid toner to said development member, said toner supply member being arranged parallel to said dosing slit so as to cover said dosing slit without sealing it.

29. The digital printing apparatus of claim 28, wherein said liquid toner dosing assembly further comprises a liquid toner supply system to continuously supply liquid toner through the liquid toner inlet orifice and to remove excess liquid toner from the liquid toner outlet orifice.

30. The digital printing apparatus of claim 28, wherein said transfer means comprises a transfuse carrier and a heater, said transfuse carrier being arranged to contact said main drum in a first zone and to contact said printing substrate in a second zone; and wherein said heater is arranged to at least partly heat said transfuse carrier downstream of said first zone and upstream of said second zone.

31. The digital printing apparatus of claim 30, further comprising a cooler arranged to at least partly cool said transfuse carrier downstream of said second zone and upstream of said first zone.

32. The digital printing apparatus of claim 26, further comprising a first substrate turning device arranged to turn a printing substrate fed into said apparatus from a substantially horizontal orientation to a substantially vertical orientation.

33. The digital printing apparatus of claim 26, further comprising a second substrate turning device arranged to turn a printing substrate ejected from said apparatus from a substantially vertical orientation to a substantially horizontal orientation.

34. The digital printing apparatus of claim 26, wherein the number of image application units is at least five.

35. The digital printing apparatus of claim 27, wherein the number of image application units is at least five.

36. A liquid toner dosing assembly comprising:
an elongate reservoir having a first end and a second end, which, in use, constitute the bottom and the top of said reservoir, respectively;
a liquid toner inlet orifice provided at said first end;
a liquid toner outlet orifice provided at said second end;
a dosing slit; and
a toner supply member for supplying liquid toner to a development member, said toner supply member being arranged parallel to said dosing slit so as to cover said dosing slit without sealing it.

37. The liquid toner dosing assembly of claim 36, further comprising means to prevent leakage of liquid toner from said reservoir through said dosing slit.

38. The liquid toner dosing assembly of claim 36, further comprising a drainage orifice at said first end.

39. The liquid toner dosing assembly of claim 36, wherein said liquid toner dosing assembly further comprises a liquid toner supply system to continuously supply liquid toner through the liquid toner inlet orifice and to remove excess liquid toner from the liquid toner outlet orifice.
